(19) United States
(12) Patent Application Publication
(10) Pub. No.: US 2012/0078495 A1
(43) Pub. Date: Mar. 29, 2012

(54) AIRCRAFT SITUATIONAL AWARENESS IMPROVEMENT SYSTEM AND METHOD

(75) Inventors: Chris Hamblin, League City, TX (US); Stephen Whitlow, St. Louis Park, MN (US); Michael Christian Dorneich, Saint Paul, MN (US); William Rogers, Minneapolis, MN (US)

(73) Assignee: HONEYWELL INTERNATIONAL INC., Morristown, NJ (US)

(21) Appl. No.: 13/053,981

(22) Filed: Mar. 22, 2011

Related U.S. Application Data
(60) Provisional application No. 61/386,792, filed on Sep. 27, 2010.

(51) Int. Cl. G08G 5/00; G05D 1/00

(52) U.S. Cl. 701/120

(57) ABSTRACT

A system and method are provided for improving aircraft pilot situational awareness. When datalink messages and/or automatic dependent surveillance-broadcast (ADS-B) data and/or various other data are received in the aircraft, the received data are processed to generate a spatial and temporal situational model for the aircraft. At least a portion of the spatial and temporal situational model is rendered on a display device within the aircraft.

### PRIORITY CLAIMS

This application claims the benefit of U.S. Provisional Application No. 61/386,792 filed Sep. 27, 2010.

### TECHNICAL FIELD

The present invention generally relates to aircraft situational awareness, and more particularly relates to a system and method for providing improved situational awareness using a situational model populated with data from various data and information sources.

### BACKGROUND

The sources of data being supplied to aircraft are increasing. Some examples of these data include automatic dependent surveillance-broadcast (ADS-B) data and datalink messaging. As is generally known, ADS-B is a cooperative surveillance technique for air traffic control and related applications. More specifically, ADS-B equipped aircraft automatically and periodically transmit state vector data, typically via a dedicated transponder. An aircraft state vector typically includes its position, airspeed, altitude, intent (e.g., whether the aircraft is turning, climbing, or descending), aircraft type, and flight number. Datalink messaging provides an additional channel of communication for pilots, and provides enhanced information flow to and from the flight deck. Indeed, datalink messaging technologies are supplanting traditional radio transmissions as the primary means of communication between aircraft and ground facilities (e.g., air traffic control).

Much of this information included in ADS-B transmissions and datalink messages could be useful to pilots if the information was properly filtered and used to build a real-world model. Currently there are no information management systems to integrate the disparate information into a coherent situation model that could be used to filter information and support situational awareness projections.

Hence, there is a need for a system and method for utilizing ADS-B and datalink message information to provide the ability to display a situational model that extends beyond sensor range. The present invention addresses at least this need.

### BRIEF SUMMARY

In one embodiment, a method for improving aircraft pilot situational awareness includes receiving and processing datalink messages and automatic dependent surveillance-broadcast (ADS-B) data in an aircraft. A spatial and temporal situational model for the aircraft is generated based on the processed datalink messages and the processed ADS-B data. At least a portion of the spatial and temporal situational model is rendered on a display device within the aircraft.

In another embodiment, an aircraft pilot situational awareness improvement system includes a display device and a processor. The display device is coupled to receive image rendering display commands and is configured, upon receipt thereof, to render one or more images. The processor is configured to receive datalink messages and automatic dependent surveillance-broadcast (ADS-B) and is configured, upon receipt thereof, to process the received datalink messages and the received ADS-B data, generate a spatial and temporal situational model for the aircraft based on the processed datalink messages and the processed ADS-B data, and supply image rendering display commands to the display device that cause the display device to render at least a portion of the spatial and temporal situational model.

Furthermore, other desirable features and characteristics of the aircraft pilot situational awareness improvement system and method will become apparent from the subsequent detailed description, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of an exemplary avionics display system 100;

FIG. 2 depicts a non-limiting example as to how a spatial and temporal situational model generated by the system of FIG. 1 may be rendered on the display device of FIG. 1; and

FIG. 3 depicts a process, in flowchart form, that may be implemented in the avionics display system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

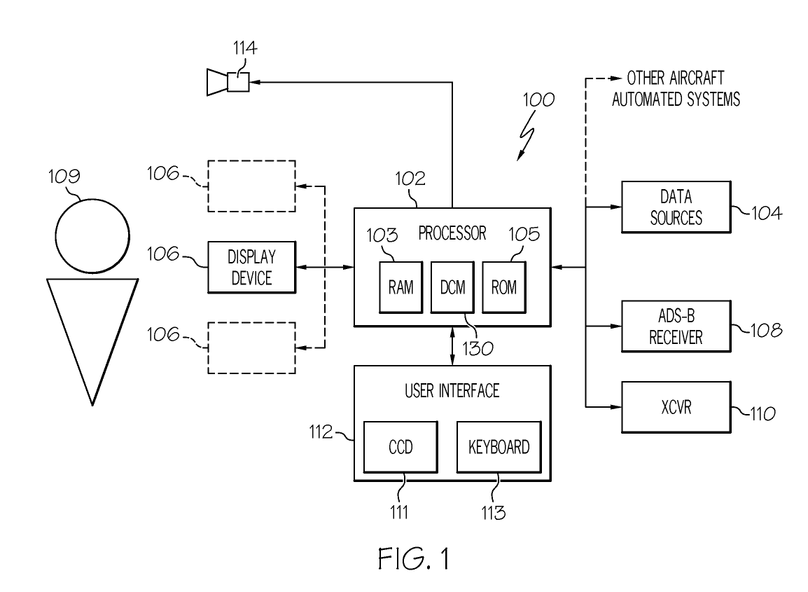

A functional block diagram of an exemplary avionics display system 100 is depicted in FIG. 1, and includes a processor 102, a plurality of data sources 104, a display device 106, an automatic dependent surveillance-broadcast (ADS-B) receiver 108, and a transceiver 110. The processor 102 is in operable communication with the data sources 104 and the display device 106. The processor 102 is coupled to receive various types of aircraft data from the data sources 104, and may be implemented using any one (or a plurality) of numerous known general-purpose microprocessors or application specific processor(s) that operates in response to program instructions. In the depicted embodiment, the processor 102 includes on-board RAM (random access memory) 103, and on-board ROM (read only memory) 105. The program instructions that control the processor 102 may be stored in either or both the RAM 103 and the ROM 105. For example, the operating system software may be stored in the ROM 105, whereas various operating mode software routines and various operational parameters may be stored in the RAM 103. It will be appreciated that this is merely exemplary of one scheme for storing operating system software and software routines, and that various other storage schemes may be implemented. It will also be appreciated that the processor 102 may be implemented using various other circuits, not just a programmable processor. For example, digital logic circuits and analog signal processing circuits could also be used. In this respect, the processor 102 may include or cooperate with any number of software programs (e.g., avionics display programs) or instructions designed to carry out various methods, process tasks, calculations, and control/display functions described below.

The data sources 104 supply the above-mentioned aircraft data to the processor 102. The data sources 104 may include a wide variety of informational systems, which may reside onboard the aircraft or at a remote location. By way of example, the data sources 104 may include one or more of a runway awareness and advisory system, an instrument landing system, a flight director system, a weather data system, a terrain avoidance and warning system, a traffic and collision avoidance system, a terrain database, an inertial reference system, a navigational database, and a flight management system. The data sources 104 may also include mode, position, and/or detection elements (e.g., gyroscopes, global positioning systems, inertial reference systems, avionics sensors, etc.) capable of determining the mode and/or position of the aircraft relative to one or more reference locations, points, planes, or navigation aids, as well as the present position and altitude of the aircraft.

The display device 106 is used to display various images and data, in a graphic, iconic, and a textual format, and to supply visual feedback to the user 109. It will be appreciated that the display device 106 may be implemented using any one of numerous known displays suitable for rendering graphic, iconic, and/or text data in a format viewable by the user 109. Non-limiting examples of such displays include various cathode ray tube (CRT) displays, and various flat panel displays, such as various types of LCD (liquid crystal display), TFT (thin film transistor) displays, and OLED (organic light emitting diode) displays. The display may additionally be based on a panel mounted display, a HUD projection, or any known technology. In an exemplary embodiment, display device 106 includes a panel display. It is further noted that the system 100 could be implemented with more than one display device 106. For example, the system 100 could be implemented with two or more display devices 106.

No matter the number or particular type of display that is used to implement the display device 106, it was noted above that the processor 102 is responsive to the various data it receives to render various images on the display device 106. The images that the processor 102 renders on the display device 106 will depend, for example, on the type of display being implemented. For example, the display device 106 may implement one or more of a multi-function display (MFD), a three-dimensional MFD, a primary flight display (PFD), a synthetic vision system (SVS) display, a vertical situation display (VSD), a horizontal situation indicator (HSI), a traffic awareness and avoidance system (TAAS) display, a three-dimensional TAAS display, just to name a few. Moreover, and as FIG. 1 depicts in phantom, the system 100 may be implemented with multiple display devices 106, each of which may implement one or more these different, non-limiting displays. The display device 106 may also be implemented in an electronic flight bag (EFB) and, in some instance, some or all of the system 100 may be implemented in an EFB.

The ADS-B receiver 108 is configured to receive ADS-B transmissions from one or more external traffic entities (e.g., other aircraft) and supplies ADS-B traffic data to the processor 102. As is generally known, ADS-B is a cooperative surveillance technique for air traffic control and related applications. More specifically, each ADS-B equipped aircraft automatically and periodically transmits its state vector. An aircraft state vector typically includes its position, airspeed, altitude, intent (e.g., whether the aircraft is turning, climbing, or descending), aircraft type, and flight number. Each ADS-B receiver, such as the ADS-B receiver 108 in the depicted system 100, that is within the broadcast range of an ADS-B transmission, processes the ADS-B transmission and supplies ADS-B traffic data to one or more other devices. In the depicted embodiment, and as was just mentioned, these traffic data are supplied to the processor 102 for additional processing. This additional processing will be described in more detail further below.

Before proceeding further it is noted that one or more of the position, airspeed, altitude, intent, aircraft type, and flight number for the one or more traffic entities may be supplied to the processor 102 from one or more data sources 104 other than the ADS-B receiver 108. For example, the data sources 104 may additionally include one or more external radar, radio, or data uplink devices that may supply, preferably in real-time, these data.

The transceiver 110 is configured to receive at least textual datalink messages that are transmitted to the flight deck system 100 via, for example, modulated radio frequency (RF) signals. The transceiver 110 demodulates the textual datalink messages, and supplies the demodulated textual datalink messages to the processor 102. The textual datalink messages include data representative of various messages between ground stations (e.g., air traffic control stations) and the host aircraft, as well as other aircraft that may be within the same aircraft sector. Thus, the processor 102 further processes the textual datalink messages and, as will be described further below, parses the messages and determines the relevance of the messages to the host aircraft. The processor 104 may also supply textual datalink messages to the transceiver 110, which in turn modulates the textual datalink messages and transmits the modulated textual datalink messages to, for example, an air traffic control station (not shown). In the depicted embodiment, the transceiver 110 is separate from the processor 102. However, it will be appreciated that the transceiver 110 could be implemented as part of the processor 102.

The depicted system 100 may also include a user interface 112 and one or more audio output devices 114. The user interface 112, if included, is in operable communication with the processor 102 and is configured to receive input from the pilot 109 and, in response to the user input, supply command signals to the processor 102. The user interface 112 may be any one, or combination, of various known user interface devices including, but not limited to, a cursor control device (CCD) 111, such as a mouse, a trackball, or joystick, and/or a keyboard, one or more buttons, switches, or knobs. In the depicted embodiment, the user interface 112 includes a CCD 111 and a keyboard 113. The pilot 109 uses the CCD 111 to, among other things, move a cursor symbol on the display device 106, and may use the keyboard 113 to, among other things, input textual data.

The audio output devices 114 may be variously implemented. No matter the specific implementation, each audio output device 114 is preferably in operable communication with the processor 102. The processor 102, other non-depicted circuits or devices, supplies analog audio signals to the output devices 114. The audio devices 114, in response to the analog audio signals, generate audible sounds. The audible sounds may include speech (actual or synthetic) or generic sounds or tones associated with alerts and notifications.

In addition to the functions described above, the processor 102 is configured to implement what is referred to herein as a data context modeler (DCM) 130. The DCM 130 collects data from one or more of the data sources 104, the ADS-B receiver 108, and datalink messages from the transceiver 110, and generates a spatial and temporal situational model for the aircraft. The DCM 130 determines the relevance of datalink messages to the host aircraft, and parses known message formats such as, for example, NOTAMS and METARS, and populates the situation model with updated data. The DCM 130 may also be configured to monitor datalink messages transmitted to other aircraft, determine the relevance of these datalink messages, and populate the situational model appropriately. The DCM 130 preferably collects all of the available ADS-B data and integrates the information into the situational model.

The DCM 130 is also preferably configured to monitor and analyze data patterns to build, identify, and categorize context models of tasks, scenarios, and phases of flight. These context models are used by the DCM 130 to identify and correlate aircraft behaviors, pilot behaviors, and the interaction of these behaviors. The situational model within the data context modeler 130 is also preferably configured to predict likely upcoming changes. The DCM 130 preferably uses statistical analyses that identify patterns of activity to predict future changes for the host aircraft. For example, if aircraft ahead of the host aircraft turn into the wind, the data context modeler 130 may generate an alert to notify the pilot 109 that he or she will likely be receiving the same clearance.

The data context modeler 130 integrates information embedded in datalink messages, along with received ADS-B transmissions and other sensor based data, to build a situational model of the host aircraft environment, which can be filtered and displayed in a single location, such as on the display device 106. The data context modeler 130, based on data received from these various data sources, continuously updates the situational model. The situational model integrates all of the received information and generates, for rendering on the display device 106, a display that improves the situational awareness of the host aircraft environment, including current state and anticipated future state.

Other aircraft automated systems may also benefit from the situational model that the DCM 130 builds. Thus, as FIG. 1 additionally depicts, the DCM 130 may be used to drive adaptive automation decisions in these systems regarding how to allocate functions, intervene, or alert. The spatial and temporal situational model is compiled from flight data and sensors onboard the host aircraft. For example, radar data will be used to build a spatial model of the air traffic while ADS-B data, datalink messages, and other data are used predict how the spatial model will change in the near future and display the situational model and predicted trajectories on the navigation display. Thus, rather than having to continuously monitor the navigation map over a period of time in order to perceive and predict the pattern changes on the map, the information is depicted graphically and is available at a glance.

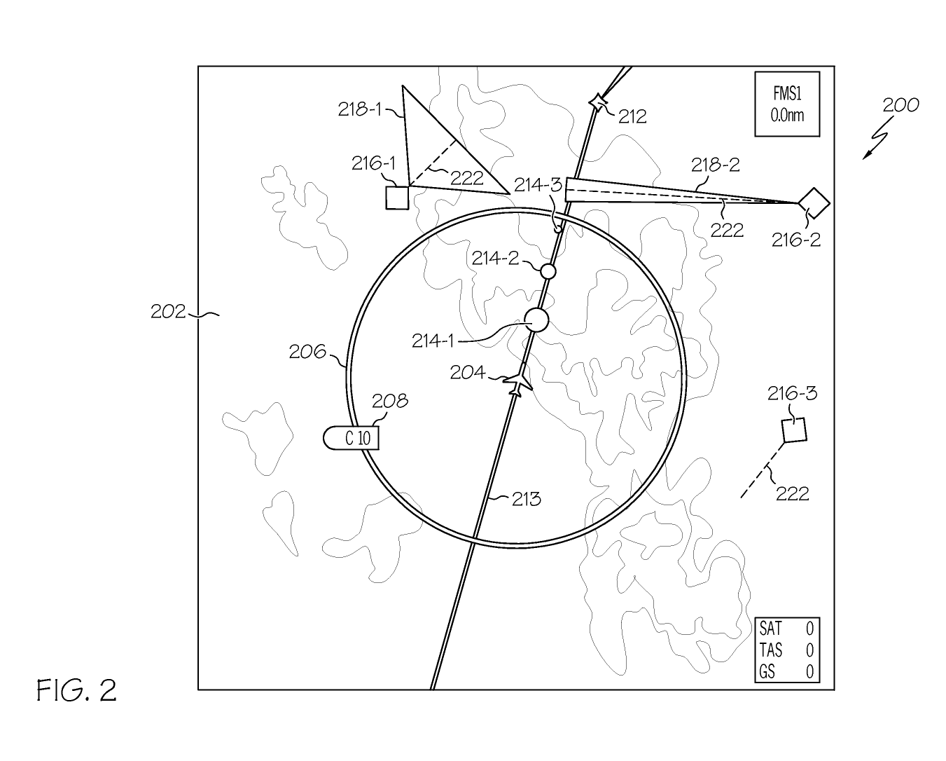

The spatial and temporal situational model may be rendered on the display device 106 using any one of numerous types of paradigms. With reference now to FIG. 2, an example image, according to one particular paradigm, that includes exemplary textual, graphical, and/or iconic information rendered on the display device 106, in response to appropriate image rendering display commands from the processor 104 is depicted. It is seen that the display device 106 simultaneously renders an image of a two-dimensional lateral situation view of terrain 202, a top-view aircraft symbol 204, various navigation aids, and various other information that will not be further described. It is noted that the rendered image 200 is merely exemplary, and is provided herein for clarity and ease of illustration and description. Indeed, the image could be rendered without terrain, or as a vertical situation view (with or without terrain), or as a perspective, three-dimensional view of the aircraft flight path (with or without terrain), just to name a few non-limiting alternatives.

The navigation aids that are rendered may also vary, but in FIG. 2 these include a range ring 206 and associated range indicator 208, one or more icons representative of various waypoints 212 along the current flight plan 213 (only one in the depicted image), a plurality of time-interval icons 214 (e.g., 214-1, 214-2, 214-3), one or more other aircraft icons 216 (e.g., 216-1, 216-2, 216-3) that are representative of other aircraft, and one or more other aircraft information icons 218 (e.g., 218-1, 218-2) that are representative of information associated with each of the other aircraft. It will be appreciated that the depicted shapes of the time-interval icons 214, the other aircraft icons 216, and the other aircraft information icons 218 are merely exemplary of one particular embodiment, and that other shapes may be used. Moreover, each of these icons may be rendered in different colors, as needed or desired.

No matter the specific shapes and colors that are used, the time-interval icons 214 are preferably rendered on the current leg of the current flight plan 213, and represent the likely future location of the aircraft. The relative locations of the time-interval icons 214 are representative of the relative time interval to reach the location represented by the time-interval icon 214, and the relative size of the time-interval icons 214 is representative of the probability of correctness. For example, the first time-interval icon 214 is rendered closer to the aircraft icon 204 and much larger than the second and third time-interval icons 214-2, 214-3. Thus indicating that the relative time to reach the location associated with the first time-interval icon 214 is less than the time to reach the locations associated with the second and third time-interval icons 214-2, 214-3, and the probability of correctness of the relative times is greater for the first time-interval icon 214-1 that it is for the second and third time-interval icons 214-2, 214-3.

The other aircraft icons 216 are rendered, at least in the depicted embodiment, as diamond-shaped icons, with dotted lines 222 emanating from one of the corners to indicate the general trajectory of the aircraft. It will be appreciated that the other aircraft icons 216 could be rendered differently, not just as diamond-shaped icons. The other aircraft information icons 218 are rendered, at least in the depicted embodiment, as triangle-shaped icons that vary in length, width, and transparency, based on the determined relevance of the of the datalink messages and on the ADS-B data received from that particular aircraft. For example, the length of the aircraft information icon 218 may vary with speed, and the width and transparency of the information icon 218 may vary with information relevance. In the depicted embodiment, the aircraft information icon 218-1 associated with the first aircraft 216 is rendered much shorter, much wider, and with slightly more transparency than the aircraft information icon 218-2 associated with the second aircraft 216-2. This indicates that the first aircraft 216-1 is traveling, along the depicted trajectory 222, at a much lower speed than that of the second aircraft 216-2, and the relevance of the datalink messages and ADS-B data received from first aircraft 216-1 are greater than those received from the second aircraft 216-2. It will additionally be appreciated that the other aircraft information icons 218 could also be rendered differently.

Before proceeding further, it should be noted that in the depicted embodiment an aircraft information icon 218 is not rendered for the third aircraft 216-3. This is because, based on the information received from the third aircraft 216-3, it neither has, nor will have, a potential spatial or temporal impact on the aircraft.

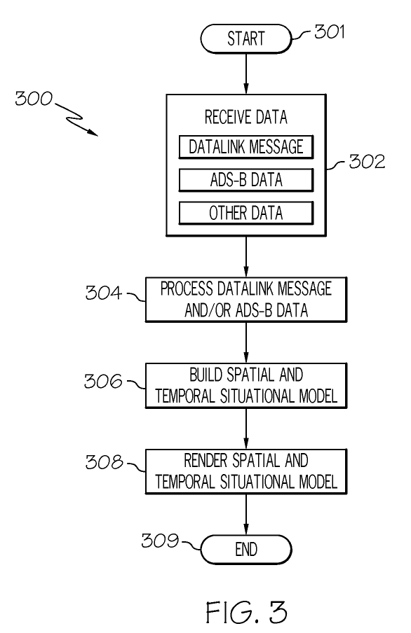

The general methodology that is implemented by the data context modeler 130, and that was described above, is depicted in flowchart form in FIG. 3. For completeness, a description of this method 300 will now be provided. In doing so, it is noted that the parenthetical references refer to like-numbered flowchart blocks.

The method 300 begins by awaiting the receipt of data, which may include a datalink message and/or ADS-B data and/or data from the other data sources 104 (302). As noted above, a received datalink message may be one that is transmitted to, and associated with, the aircraft in which the system 100 is installed, or it may be transmitted to, and associated with, another aircraft. In either case, when a datalink message and/or ADS-B data and/or other data are received, it is supplied to the processor 102. The processor 102, implementing the data context modeler 130, then processes the datalink message and/or ADS-B data and or other data (304). The processor 102, implementing the data context modeler 130, builds and/or updates the spatial and temporal situational model for the aircraft based on the processed datalink messages and/or ADS-B data and/or other data (306). The spatial and temporal situational model then rendered on the display device 106 (308).

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention.

What is claimed is:

1. A method for improving aircraft pilot situational awareness, comprising the steps of:
receiving datalink messages in an aircraft;
receiving automatic dependent surveillance-broadcast (ADS-B) data in the aircraft;
processing the received datalink messages;
processing the received ADS-B data;
generating a spatial and temporal situational model for the aircraft based on the processed datalink messages and the processed ADS-B data; and
rendering at least a portion of the spatial and temporal situational model on a display device within the aircraft.

2. The method of claim 1, wherein the step of processing the received datalink messages comprises:
parsing each of the received datalink messages into individual information elements; and
assessing the relevance of each the received datalink messages from the individual information elements.

3. The method of claim 2, further comprising:
generating the spatial and temporal situational model based on the assessed relevance of each of the received datalink messages.

4. The method of claim 2, wherein the received datalink messages include datalink messages transmitted to other aircraft.

5. The method of claim 1, further comprising:
processing data representative of aircraft mode and position,
wherein the spatial and temporal situational model for the aircraft is generated based additionally on the processed sensor data.

6. The method of claim 1, further comprising:
generating context models of tasks, scenarios, and phases of flight based on the processed datalink messages and the processed ADS-B data; and
identifying and correlating aircraft behaviors, pilot behaviors, and interactions of the aircraft and pilot behaviors.

7. The method of claim 1, further comprising:
statistically analyzing the processed datalink messages and the processed ADS-B data to identify patterns of activity of other aircraft; and
predicting future changes for the aircraft based on the identified patterns of activity.

8. The method of claim 1, wherein the step of rendering at least a portion of the spatial and temporal situational model comprises:
rendering at least a portion of the current flight plan for the aircraft;
rendering a plurality of time-interval icons on at least a portion of the rendered current flight plan, each time interval icon rendered at a position on the current flight plan and with a size representative of a relative time interval to reach the position represented by the time-interval icon.

9. The method of claim 1, wherein the step of rendering at least a portion of the spatial and temporal situational model comprises:
rendering one or more other aircraft icons, each rendered aircraft icon representative of an other aircraft; and
rendering one or more other aircraft information icons, each rendered other aircraft information icon representative of information associated with one of the other aircraft.

10. The method of claim 9, further comprising:
rendering symbology indicating a general trajectory of the other aircraft; and
rendering each other aircraft information icon as a triangle-shaped icon that varies in length, width, and transparency, based at least in part on the received datalink messages and the received ADS-B data.

11. An aircraft pilot situational awareness improvement system, comprising:
a display device coupled to receive image rendering display commands and configured, upon receipt thereof, to render one or more images; and
a processor configured to receive datalink messages and automatic dependent surveillance-broadcast (ADS-B) and configured, upon receipt thereof, to:
process the received datalink messages and the received ADS-B data;
generate a spatial and temporal situational model for the aircraft based on the processed datalink messages and the processed ADS-B data; and
supply image rendering display commands to the display device that cause the display device to render at least a portion of the spatial and temporal situational model.

12. The system of claim 11, wherein the processor is further configured to:
parse each of the received datalink messages into individual information elements; and
assess the relevance of each the received datalink messages from the individual information elements.

13. The system of claim 12, wherein the processor is further configured to:
generate the spatial and temporal situational model based on the assessed relevance of each of the received datalink messages.

14. The system of claim 12, wherein the received datalink messages include datalink messages transmitted to other aircraft.

15. The system of claim 11, wherein the processor is further configured to:
receive and process data representative of aircraft mode and position; and
generate the spatial and temporal situational model for the aircraft based additionally on the processed sensor data.

16. The system of claim 11, wherein the processor is further configured to:
generate context models of tasks, scenarios, and phases of flight based on the processed datalink messages and the processed ADS-B data; and
identify and correlate aircraft behaviors, pilot behaviors, and interactions of the aircraft and pilot behaviors.

17. The system of claim 11, wherein the processor is further configured to:
statistically analyze the processed datalink messages and the processed ADS-B data to identify patterns of activity of other aircraft; and
predict future changes for the aircraft based on the identified patterns of activity.

18. The system of claim 1, wherein the rendered spatial and temporal situational model comprises:
at least a portion of the current flight plan for the aircraft;
a plurality of time-interval icons on at least a portion of the rendered current flight plan, each time interval icon rendered at a position on the current flight plan and with a size representative of a relative time interval to reach the position represented by the time-interval icon.

19. The system of claim 11, wherein the rendered spatial and temporal situational model comprises:
one or more other aircraft icons, each rendered aircraft icon representative of an other aircraft; and
one or more other aircraft information icons, each rendered other aircraft information icon representative of information associated with one of the other aircraft.

20. The system of claim 19, wherein:
each of the other aircraft icons includes symbology to indicate a general trajectory of the other aircraft; and
each other aircraft information icon is rendered as a triangle-shaped icon that varies in length, width, and transparency, based at least in part on the received datalink messages and the received ADS-B data.
